(19) United States
(12) Patent Application Publication
(10) Pub. No.: US 2024/0230340 A9
(43) Pub. Date: Jul. 11, 2024

(54) Shoe Monitoring Assembly

(71) Applicant: Holly Bowen, Battlement Mesa, CO (US)

(72) Inventor: Holly Bowen, Battlement Mesa, CO (US)

(21) Appl. No.: 17/973,486

(22) Filed: Oct. 25, 2022

(51) Int. Cl. G01C 21/28; A43B 3/46; A43B 5/06; G01C 22/00; G01K 1/16; G01K 13/00

(52) U.S. Cl. CPC G01C 21/28; A43B 3/46; A43B 5/06; G01C 22/006; G01K 1/16; G01K 13/00

(57) ABSTRACT

A shoe monitoring assembly includes an article of footwear that is wearable on a user's foot. The article of footwear has a storage pocket that is integrated into a tongue of the article of footwear. A tracking unit is positioned within the storage pocket and the tracking unit is in remote communication with a global positioning system for tracking the speed with which the user moves. A temperature sensor is integrated into the article of footwear to sense the temperature of a support surface upon which the user is walking to determine if the temperature of the support surface is safe to walk upon with bare feet. An accelerometer is integrated into the article of footwear thereby to track the number of steps the user takes.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to monitoring devices and more particularly pertains to a new monitoring device for tracking various aspects of a user's motion with respect to walking or running. The device includes an article of footwear and a pocket integrated into a tongue of the article of footwear. The device includes a tracking unit that is positioned in the pocket which is in communication with a global positioning system. The device includes a temperature sensor integrated into a sole of the article of footwear for sensing the temperature of the surface upon which the user is walking and an accelerometer integrated into the sole for counting the number of steps the user takes.

### (2) Description of Related Art Including Information Disclosed Under 37 CFR 1.97 and 1.98

The prior art relates to monitoring devices including a wearable device that receives a first wake-up signal from a first detected activity location and a second wake-up signal from a second detected activity location. The prior art discloses a footwear system that includes an article of footwear and a plurality of pressure sensors integrated into a sole of the article of footwear. The prior art discloses a smart shoe system that includes an article of footwear that includes a plurality of pressure sensors positioned at strategic locations on the article of footwear and a global positioning circuit. The prior art discloses a footwear sensor unit that includes an article of footwear, a sensor integrated into the article of footwear, an accelerometer integrated into the article of footwear and a gyroscope integrated into the article of footwear.

### BRIEF SUMMARY OF THE INVENTION

An embodiment of the disclosure meets the needs presented above by generally comprising an article of footwear that is wearable on a user's foot. The article of footwear has a storage pocket that is integrated into a tongue of the article of footwear. A tracking unit is positioned within the storage pocket and the tracking unit is in remote communication with a global positioning system for tracking the speed with which the user moves. A temperature sensor is integrated into the article of footwear to sense the temperature of a support surface upon which the user is walking to determine if the temperature of the support surface is safe to walk upon with bare feet. An accelerometer is integrated into the article of footwear thereby to track the number of steps the user takes.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a bottom phantom view of a shoe monitoring assembly according to an embodiment of the disclosure.

FIG. 2 is a front phantom view of an embodiment of the disclosure.

FIG. 3 is a cross sectional view taken along line 3-3 of FIG. 2 of an embodiment of the disclosure.

FIG. 4 is a perspective in-use view of an embodiment of the disclosure.

FIG. 5 is a schematic view of an embodiment of the disclosure.

### DETAILED DESCRIPTION OF THE INVENTION

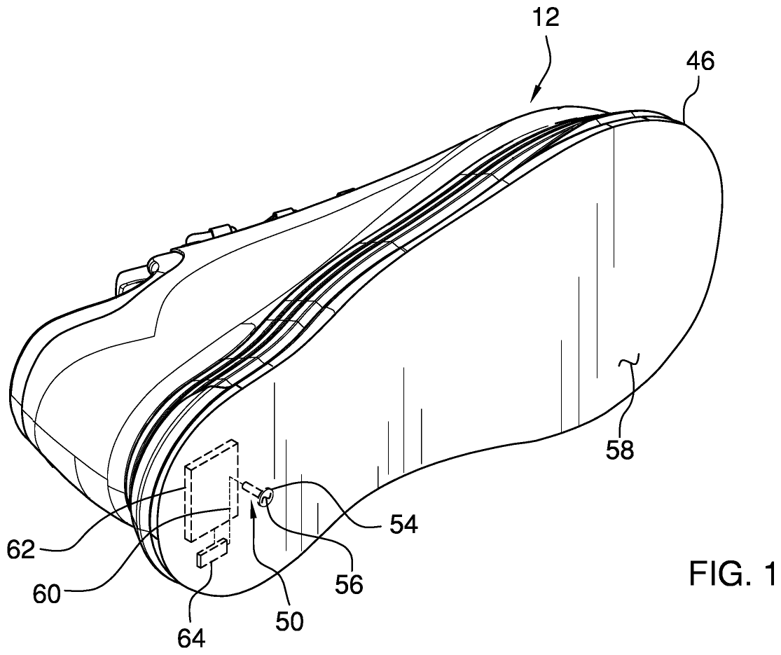

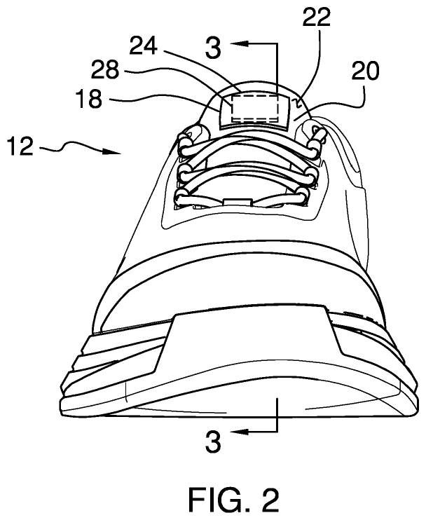

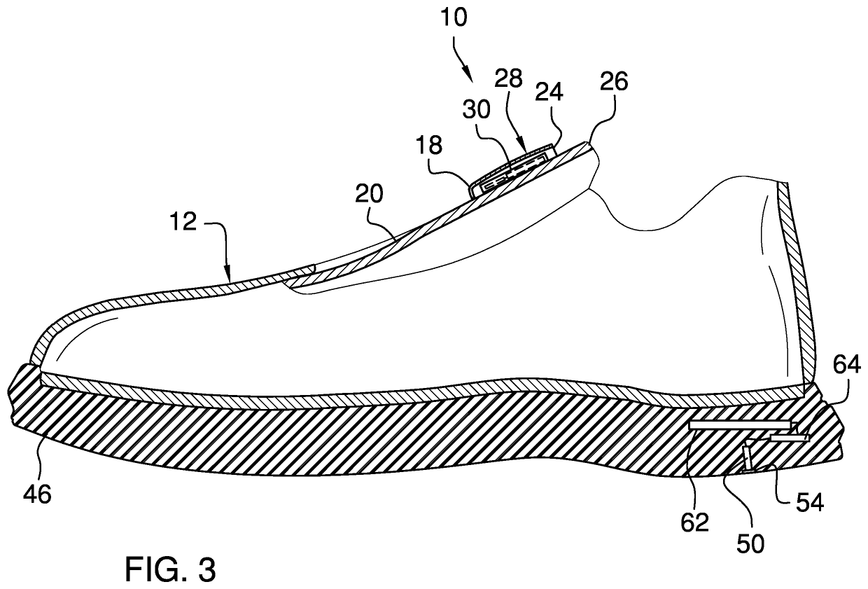

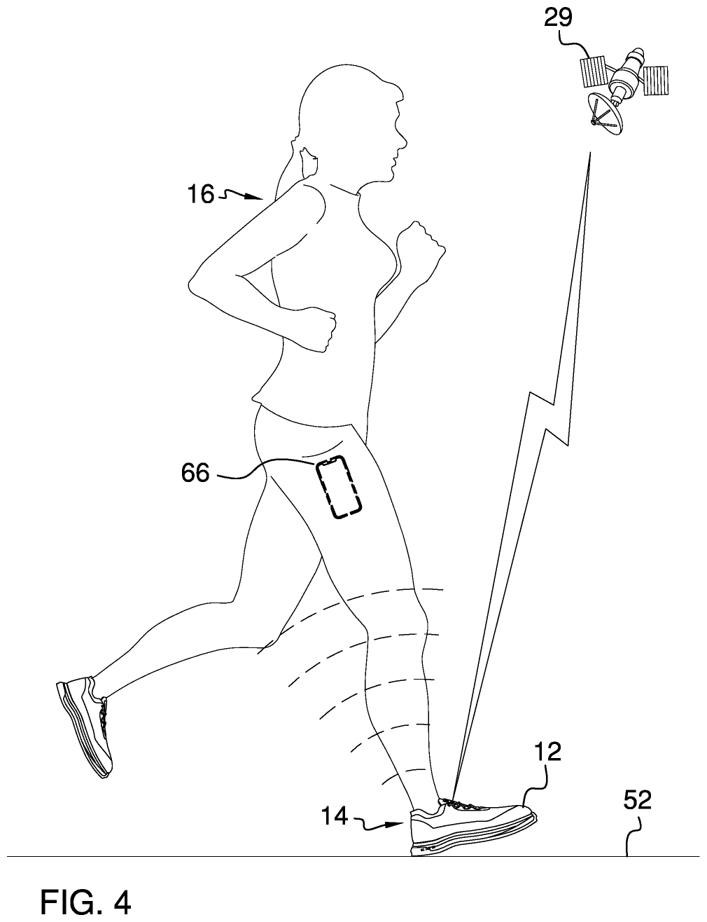

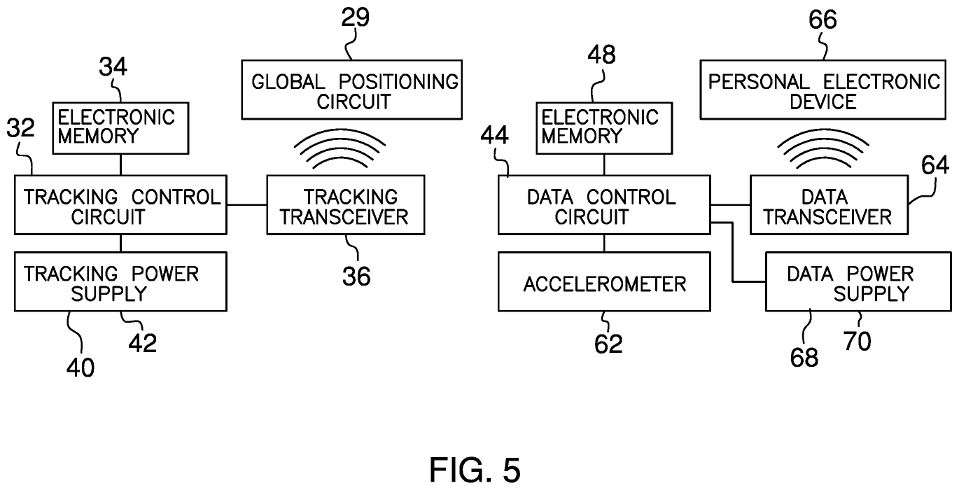

With reference now to the drawings, and in particular to FIGS. 1 through 5 thereof, a new monitoring device embodying the principles and concepts of an embodiment of the disclosure and generally designated by the reference numeral 10 will be described.

As best illustrated in FIGS. 1 through 5, the shoe monitoring assembly 10 generally comprises an article of footwear 12 that is wearable on a foot 14 of a user 16. The article of footwear 12 may comprise a tennis shoe or other type of footwear 12 that would be worn for walking, running or other outdoor activity. The article of footwear 12 has a storage pocket 18 that is integrated into a tongue 20 of the article of footwear 12. The storage pocket 18 is positioned on an outwardly facing surface 22 of the tongue 20 thereby facilitating the storage pocket 18 to be accessible to the user 16. The storage pocket 18 has an open end 24 that is open to access an interior of the storage pocket 18 and the open end 24 is directed toward a free end 26 of the tongue 20 thereby enhancing access to the open end 24.

A tracking unit 28 is provided and the tracking unit 28 is positioned within the storage pocket 18. The tracking unit 28 is in remote communication with a global positioning system 29 thereby facilitating the tracking unit 28 to establish a physical location of the article of footwear 12 thereby facilitating a speed of the article of footwear 12 to be tracked with respect to the user 16 running or walking. In this way the tracking unit 28 facilitates the user 16 to subsequently analyze data collected by the tracking unit 28. Furthermore, the tracking unit 28 facilitates the user 16 to be located by a third party (via employing the global positioning signal) if the user 16 becomes lost, if the user 16 is abducted or if the user 16 finds themselves in any type of situation that would inhibit the user 16 from being able to willingly return to their home.

The tracking unit 28 comprises a tracking housing 30 that is insertable into the open end 24 of the storage pocket 18. The tracking unit 28 includes a tracking control circuit 32 that is integrated into the tracking housing 30 and the tracking control circuit 32 includes an electronic memory 34. The tracking unit 28 includes a tracking transceiver 36 that is integrated into the tracking housing 30 and the tracking transceiver 36 is electrically coupled to the tracking control circuit 32. The tracking transceiver 36 is in wireless communication with the global positioning system 29 thereby facilitating the tracking transceiver 36 to establish the physical location of the tracking housing 30. Additionally, the electronic memory 34 stores data received by the tracking transceiver 36 for subsequently download or analysis. The tracking transceiver 36 may comprise a radio frequency transceiver or the like and the tracking transceiver 36 may employ a global positioning system signal. The tracking unit 28 includes a tracking power supply 40 that is integrated into the tracking housing 30 and the tracking power supply 40 comprises at least one battery 42.

A data control circuit 44 is integrated into a sole 46 of the article of footwear 12 and the data control circuit 44 includes an electronic memory 48. A temperature sensor 50 is integrated into the article of footwear 12 and the temperature sensor 50 is strategically located thereby facilitating the temperature sensor 50 to be in thermal communication with a support surface 52 upon which the user 16 is walking. In this way the temperature sensor 50 can sense the temperature of the support surface 52 to facilitate the user 16 to determine if the temperature of the support surface 52 is safe to walk upon with bare feet. The temperature sensor 50 is integrated into a sole 46 of the article of footwear 12 and the temperature sensor 50 has a sensing element 54 which has a sensing surface 56 that is aligned with a bottom surface 58 of the sole 46. In this way the sensing element 54 can touch the support surface 52 when the user 16 walks or runs on the support surface 52. Furthermore, the sensing surface 56 is comprised of a thermally conductive material thereby facilitating the sensing surface 56 to be in thermal communication with the support surface 52.

A conductor 60 is integrated into the sole 46 of the article of footwear 12 and the conductor 60 is electrically coupled between the sensing element 54 of the temperature sensor 50 and the data control circuit 44 such that the temperature sensor 50 is in electrical communication with the data control circuit 44. Additionally, the electronic memory 48 associated with the data control circuit 44 stores data collected by the temperature sensor 50. The conductor 60 is comprised of an electrically conductive material, such as copper wire, and the electronic memory 48 associated with the data control circuit 44 may comprise random access memory or other type of digital data storage.

An accelerometer 62 is integrated into the article of footwear 12 thereby facilitating the accelerometer 62 to detect when the article of footwear 12 accelerates and decelerates to track the number of steps the user 16 takes. The accelerometer 62 is integrated into the sole 46 of the article of footwear 12 and the accelerometer 62 is electrically coupled to the data control circuit 44 such that the electronic memory 48 associated with the data control circuit 44 stores data collected by the accelerometer 62. The accelerometer 62 may comprise an electronic accelerometer or other type of accelerometer that can detect the motion associated with taking steps for walking or running.

A data transceiver 64 is integrated into the sole 46 of the article of footwear 12 and the data transceiver 64 is electrically coupled to the data control circuit 44. The data transceiver 64 is in wireless communication with a personal electronic device 66 thereby facilitating the data transceiver 64 to upload data stored in the electronic memory 48 associated with the data control circuit 44 into the personal electronic device 66. In this way the data transceiver 64 facilitates the user 16 to subsequently analyze data received from the data transceiver 64, including the temperature sensed by the temperature sensor 50 and the number of steps the accelerometer 62 has counted. The data transceiver 64 may comprise a radio frequency transceiver or the like and the data transceiver 64 may employ Bluetooth communication protocols. The personal electronic device 66 may comprise a smart phone or other type of electronic device that has wireless communication capabilities and data storage capabilities. A data power supply 68 is integrated into the sole 46 of the article of footwear 12, the data power supply 68 is electrically coupled to the data control circuit 44 and the data power supply 68 comprises at least one battery 70.

In use, the article of footwear 12 is worn on the user's foot 14 when the user 16 is going walking, running or performing any type of outdoor activity. The accelerometer 62 counts the number of steps the user 16 takes and the temperature sensor 50 monitors the temperature of the support surface 52 upon which the user 16 is walking. The data collected by the accelerometer 62 and the temperature sensor 50 can be downloaded into the personal electronic device 66 to facilitate the user 16 to analyze the data. Furthermore, the tracking unit 28 facilitates the user 16 to determine the distance they ran or walked as well as to facilitate the user 16 to be located in the event the user 16 becomes lost or is otherwise unable to willingly return to their home.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A shoe monitoring assembly for tracking the speed of a user while walking and monitoring environmental conditions, said assembly comprising:
an article of footwear being wearable on a user's foot, said article of footwear having a storage pocket being integrated into a tongue of said article of footwear;
a tracking unit being positioned within said storage pocket, said tracking unit being in remote communication with a global positioning system thereby facilitating said tracking unit to establish a physical location of said article of footwear thereby facilitating a speed of said article of footwear to be tracked with respect to the user running or walking wherein said tracking unit is configured to facilitate the user to subsequently analyze data collected by said tracking unit;
a temperature sensor being integrated into said article of footwear, said temperature sensor being strategically located thereby facilitating said temperature sensor to be in thermal communication with a support surface upon which the user is walking to sense the temperature of the support surface wherein said temperature sensor is configured to facilitate the user to determine if the temperature of the support surface is safe to walk upon with bare feet; and
an accelerometer being integrated into said article of footwear thereby facilitating said accelerometer to detect when said article of footwear accelerates and decelerates wherein said accelerometer is configured to track the number of steps the user takes.

2. The assembly according to claim 1, wherein:
said storage pocket is positioned on an outwardly facing surface of said tongue thereby facilitating said storage pocket to be accessible to the user, said storage pocket having an open end being open to access an interior of said storage pocket, said open end being directed toward a free end of said tongue thereby enhancing access to said open end; and
said tracking unit comprises:
a tracking housing being insertable into said open end of said storage pocket;
a tracking control circuit being integrated into said tracking housing, said tracking control circuit including an electronic memory;
a tracking transceiver being integrated into said tracking housing, said tracking transceiver being electrically coupled to said tracking control circuit, said tracking transceiver being in wireless communication with a global positioning system thereby facilitating said tracking transceiver to establish the physical location of said tracking housing, said electronic memory storing data received by said tracking transceiver; and
a tracking power supply being integrated into said tracking housing, said tracking power supply comprising at least one battery.

3. The assembly according to claim 1, wherein:
said assembly includes a data control circuit being integrated into a sole of said article of footwear, said data control circuit including an electronic memory;
said temperature sensor is integrated into a sole of said article of foot wear, said temperature sensor having a sensing element which has a sensing surface, said sensing surface being aligned with a bottom surface of said sole thereby facilitating said sensing element to touch the support surface when the user walks or runs on the support surface, said sensing surface being comprised of a thermally conductive material thereby facilitating said sensing surface to be in thermal communication with the support surface; and
a conductor being integrated into said sole of said article of footwear, said conductor being electrically coupled between said sensing element of said temperature sensor and said data control circuit such that said temperature sensor is in electrical communication with said data control circuit, said electronic memory associated with said data control circuit storing data collected by said temperature sensor.

4. The assembly according to claim 3, wherein said accelerometer being integrated into said sole of said article of footwear, said accelerometer being electrically coupled to said data control circuit such that said electronic memory associated with said data control circuit stores data collected by said accelerometer.

5. The assembly according to claim 3, further comprising:
a data transceiver being integrated into said sole of said article of footwear, said data transceiver being electrically coupled to said data control circuit, said data transceiver being in wireless communication with a personal electronic device thereby facilitating said data transceiver to upload data stored in said electronic memory associated with said data control circuit into the personal electronic device wherein said data transceiver is configured to facilitate the user to subsequently analyze data received from said data transceiver; and
a data power supply being integrated into said sole of said article of footwear, said data power supply being electrically coupled to said data control circuit, said data power supply comprising at least one battery.

6. A shoe monitoring assembly for tracking the speed of a user while walking and monitoring environmental conditions, said assembly comprising:
an article of footwear being wearable on a user's foot, said article of footwear having a storage pocket being integrated into a tongue of said article of footwear, said storage pocket being positioned on an outwardly facing surface of said tongue thereby facilitating said storage pocket to be accessible to the user, said storage pocket having an open end being open to access an interior of said storage pocket, said open end being directed toward a free end of said tongue thereby enhancing access to said open end;
a tracking unit being positioned within said storage pocket, said tracking unit being in remote communication with a global positioning system thereby facilitating said tracking unit to establish a physical location of said article of footwear thereby facilitating a speed of said article of footwear to be tracked with respect to the user running or walking wherein said tracking unit is configured to facilitate the user to subsequently analyze data collected by said tracking unit, said tracking unit comprising:
a tracking housing being insertable into said open end of said storage pocket;
a tracking control circuit being integrated into said tracking housing, said tracking control circuit including an electronic memory;
a tracking transceiver being integrated into said tracking housing, said tracking transceiver being electrically coupled to said tracking control circuit, said tracking transceiver being in wireless communication with a global positioning system thereby facilitating said tracking transceiver to establish the physical location of said tracking housing, said electronic memory storing data received by said tracking transceiver; and
a tracking power supply being integrated into said tracking housing, said tracking power supply comprising at least one battery;
a data control circuit being integrated into a sole of said article of footwear, said data control circuit including an electronic memory;
a temperature sensor being integrated into said article of footwear, said temperature sensor being strategically located thereby facilitating said temperature sensor to be in thermal communication with a support surface upon which the user is walking to sense the temperature of the support surface wherein said temperature sensor is configured to facilitate the user to determine if the temperature of the support surface is safe to walk upon with bare feet, said temperature sensor being integrated into a sole of said article of foot wear, said temperature sensor having a sensing element which has a sensing surface, said sensing surface being aligned with a bottom surface of said sole thereby facilitating said sensing element to touch the support surface when the user walks or runs on the support surface, said sensing surface being comprised of a thermally conductive material thereby facilitating said sensing surface to be in thermal communication with the support surface;
a conductor being integrated into said sole of said article of footwear, said conductor being electrically coupled between said sensing element of said temperature sensor and said data control circuit such that said temperature sensor is in electrical communication with said data control circuit, said electronic memory associated with said data control circuit storing data collected by said temperature sensor;
an accelerometer being integrated into said article of footwear thereby facilitating said accelerometer to detect when said article of footwear accelerates and decelerates wherein said accelerometer is configured to track the number of steps the user takes, said accelerometer being integrated into said sole of said article of footwear, said accelerometer being electrically coupled to said data control circuit such that said electronic memory associated with said data control circuit stores data collected by said accelerometer;
a data transceiver being integrated into said sole of said article of footwear, said data transceiver being electrically coupled to said data control circuit, said data transceiver being in wireless communication with a personal electronic device thereby facilitating said data transceiver to upload data stored in said electronic memory associated with said data control circuit into the personal electronic device wherein said data transceiver is configured to facilitate the user to subsequently analyze data received from said data transceiver; and
a data power supply being integrated into said sole of said article of footwear, said data power supply being electrically coupled to said data control circuit, said data power supply comprising at least one battery.
